(19) United States
(12) Patent Application Publication
(10) Pub. No.: US 2003/0019198 A1
(43) Pub. Date: Jan. 30, 2003

(54) Tiller tine mower

(75) Inventor: Jimmy N. Eavenson SR., Aurora, OH (US)

Correspondence Address: Heather M. Barnes, Esq., Fourteenth Floor, One Cascade Plaza, Akron, OH, 44308, US

(73) Assignee: Commercial Turf Products, LTD., Streetsboro, OH

(21) Appl. No.: 09/912,108

(22) Filed: Jul. 24, 2001

(51) Int. Cl. A01D 34/64

(52) U.S. Cl. 56/16.7

(57) ABSTRACT

A ground engaging vegetation mower has a mower deck with a horizontally mounted blade shaft. Cutting blades, having a U-shaped cross section, are mounted symmetrically about the blade shaft for rotation therewith. The cutting blades rotate within sufficient proximity to the mower deck housing so as to provide scissor-like cutting action of the vegetation. The mounting of the cutting blades on the shaft is such that contact with an obstruction causes the cutting blades to slip about the blade shaft. A plurality of cutting blades can be selectively attached to the blade shaft to adjust the cutting width of the mower deck.

### I. BACKGROUND OF THE INVENTION

A. Field of the Invention

This invention relates to the art of lawn mowers and more specifically to a tiller tine mower.

B. Description of the Related Art

It is well known in the art to provide a rotating blade on lawn mowers for use in cutting vegetation, and more commonly grass. There are numerous types of mowers; including rotary mowers having blades rotating substantially parallel with the ground, mulching mowers and reel-type mowers. The following patents disclose several mowers related to the art of vegetation mowing or grass cutting.

U.S. Pat. No. 5,205,122 to Tillotson et al. discloses a mower including two separate cutting chambers, which are staggered forwardly relative to one another. The patent further discloses a peripheral wall of the forward cutting chamber having a selectively openable gate, which is closed in the mulching mode but is open in the discharge or collection mode. The object of this invention centers on cutting larger areas of grass while providing mulching action that does not degrade the performance of the mower or allow buildup of cut grass within the cutting chambers.

U.S. Pat. No. 5,867,973 to Geier discloses an adjustable rotary mower that re-cuts grass into mulch. The patent further discloses angled flanges that mount to the blade of the mower. The flanges are angled such that each in succession is alternating above and below the plane of the blade. This allows for the grass to be re-cut producing a mulching action.

The inventions of the above mentioned patents incorporate blades rotating in a plane generally parallel to the associated ground. One problem that occurs with mowers of this type is drag produced by the surface area of the blade coming into friction contact with the surface of the vegetation to be mowed. The larger the surface area, the greater the drag produced on the mower blade, therefore reducing the efficiency of the mower and mower engine.

Rotary mowers of this type are also known to laterally discharge severed grass, along with extraneous debris. To some, this is not desirable.

U.S. Pat. No. 5,400,575 to Smith discloses a reel-type lawn mower with a mulching attachment. The patent further discloses that the mulching attachment utilizes the air current created by the revolving blades of the reel-type mower which acts to disperse the cut grass in front of the mower where it is then re-cut into finer particles before deposited as a mulch to the ground.

U.S. Pat. No. 4,995,227 to Foster discloses a reel-type lawn mower propelled by an electric motor. The patent further discloses that the cutting reel is propelled by the electric motor and the drive wheels, which are operatively connected to the cutting reel. The patent cites that the object of this invention is to provide a relatively simple lawn mower having an improved power sharing arrangement between the electric motor and the manual power imparted by the user of the lawn mower pushing the lawn mower along the ground.

A problem incurred by reel-type mowers is that the cutting width of the mower blade is fixed and cannot be altered.

Still another problem that is incurred by reel-type mowers is the inadvertent contact of the mower blade with rocks or other debris that can cause damage to the blade from impacting such an object.

It would therefore be desirable to provide a mower that would operate with greater efficiency and safety, along with providing a superior cut of grass. Additionally, it would desirable to provide a mower with an easily adjustable cut-width dimension.

### II. SUMMARY OF THE INVENTION

It is an object of the present invention to provide a vegetation mowing apparatus that provides a cutting action where there is no lateral discharge of severed vegetation, or grass, and additional debris.

It is another object of the present invention to provide a mower with scissors-like cutting action.

It is still another object of the present invention to provide a mower that operates with a reduced noise level.

It is even yet another object of the present invention to provide such a mower to include mulching action.

It is further another object of the present invention to provide a mower with blades that slip when encountering inadvertent objects.

It is another object of the present invention to provide a mower with a reduced rotational speed of the mower blades.

In accordance with the present invention, there is provided a mower having a frame and wheels for enabling the mower to travel over the vegetation or grass. The mower includes cutting blades for the purpose of cutting the associated vegetation. The mower includes an engine for driving the mower and the mower blades, of which the blades are U-shaped, or in an alternate embodiment L-shaped.

The mower blades are mounted to and rotate about a shaft that is substantially parallel to the associated ground. The mower blades are encased within a housing that contains a knife-like surface that is closely disposed to the rotating edge of the mower blades resulting in a scissors-like shearing action of the vegetation. This provides a sharper and higher quality cut of the vegetation.

The blades are rotated by friction contact of a clutch mechanism where a compression spring, or other such means as is chosen with sound engineering judgement, forces the blades into contact with the rotating shaft components. Should one of more of the blades come into contact with extraneous debris, such as a rock or other rigid matter, the blade or blades will slip thereby limiting damage.

Other objects and advantages of the invention will appear from the following detailed description of the preferred embodiment of the invention with reference being made to the accompanying drawings.

### III. BRIEF DESCRIPTION OF DRAWINGS

The invention may take physical form in certain parts and arrangement of parts, a preferred embodiment of which will be described in detail in this specification and illustrated in the accompanying drawings which form a part hereof and wherein:

FIG. 1 depicts a side perspective view of a tiller-tine mower.

FIG. 2 is a partial cut-away view of the tiller-tine mower shown in FIG. 1.

FIG. 3 is a side view of a blade shaft.

FIG. 4 shows the blade shaft of FIG. 3 with a pulley and clutch plate attached to the blade shaft.

FIG. 5 is a perspective view of a U-shaped cutting blade.

FIG. 6 is a perspective view of a spacer juxtaposed to a U-shaped cutting blade.

FIG. 7 is a perspective view of an alternate embodiment of a cutting blade with a spacer integrated into the cutting blade.

FIG. 8 is a perspective view of a cutting blade and spacer operatively connected to the blade shaft and pulley.

FIG. 9 is a perspective view of a spring force operatively engaging the cutting blade with the clutch surface.

FIG. 10 is a perspective view of an alternate embodiment of a cutting blade and spacer.

FIG. 11 is a perspective view of a multiple U-shaped cutting blades with spacers juxtaposed along the blade shaft.

FIG. 12 is a perspective view of a multiple U-shaped cutting blade with spacers juxtaposed along the blade shaft with the cutting blades overlapping.

FIG. 13 is a perspective view of multiple U-shaped cutting blades with spacers juxtaposed along the blade shaft with the cutting blades overlapping.

FIG. 14 is a perspective view of multiple U-shaped cutting blades with an index member fixing the angle by which the cutting blades are staggered about the blade shaft.

FIG. 15 is a side view of the mower showing the scissor cutting action of the cutting blade with an edge of the mower deck.

### IV. DETAILED DESCRIPTION OF THE INVENTION

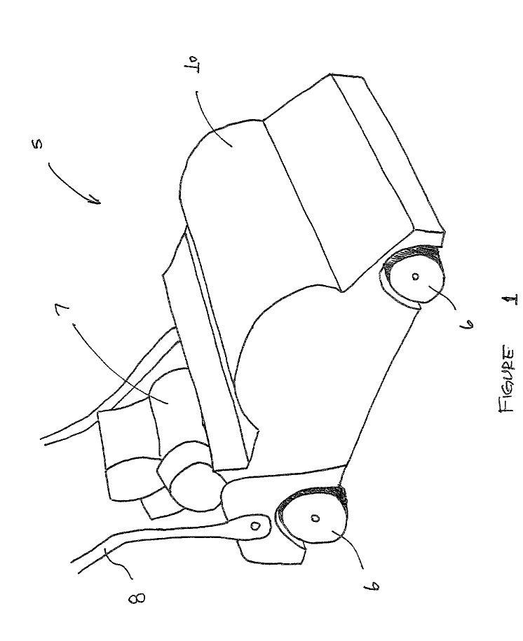

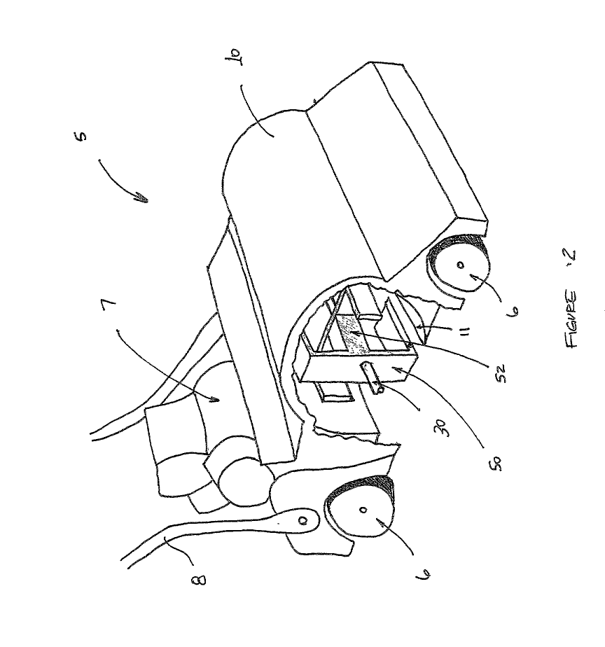

Referring now to the drawings wherein the showings are for purposes of illustrating a preferred embodiment of the invention only and not for purposes of limiting the same, FIGS. 1 and 2 show a tiller tine-mower, depicted generally at 5, and having a mower deck 10, ground engaging wheels 6, an engine 7 and a handle 8 extending from mower deck 10 for use in guiding the mower 5. In the preferred embodiment, the mower is a walk-behind mower, although the present inventive mower deck 10 can be incorporated onto any type of vegetation mowing device such as a riding mower. Also, in the preferred embodiment, the engine 7 is an internal combustion engine for use in providing power to drive the mower blades and the wheels of the mower. However, any such driving means may be chosen with sound engineering judgment as is appropriate for a mowing device. FIGS. 1 and 2 depict four (4) ground-engaging wheels 6, two of which are not shown, operatively attached to the mower as related to the preferred embodiment. In an alternate embodiment, any number of wheels may be chosen with sound engineering judgment as is appropriate for a vegetation mower. The housing 10 as shown in FIG. 2 shrouds a blade shaft 30, blades 50 and associated components. The blade shaft 30 and blades 50 are rotatably mounted therein and in such proximity to the associated ground and vegetation whereby rotation of the blades and movement of the mower 5 facilitates a cutting of the associated vegetation.

Referring now to FIG. 2, a partial cut-away view of the mower of the preferred embodiment shows a blade shaft 30 and cutting blade 50. The elongate blade shaft 30 has a first longitudinal axis and is operatively mounted to the housing 10 of the mower 5 at first and second ends of the blade shaft. Each of said first and second ends are rotatably attached to a bearings or any means of allowing rotation of the blade shaft 30 about the longitudinal axis, as is chosen with sound engineering judgment. Operably attached to the blade shaft 30 is a plurality of cutting blades 50. The blades 50 are attached such that rotation about the longitudinal axis of the blade shaft 30 facilitates cutting of the associated vegetation.

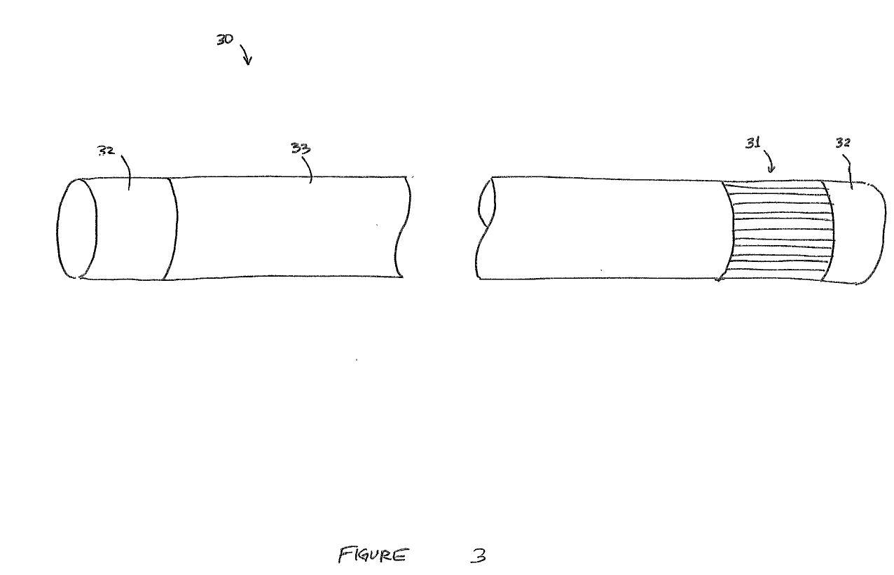

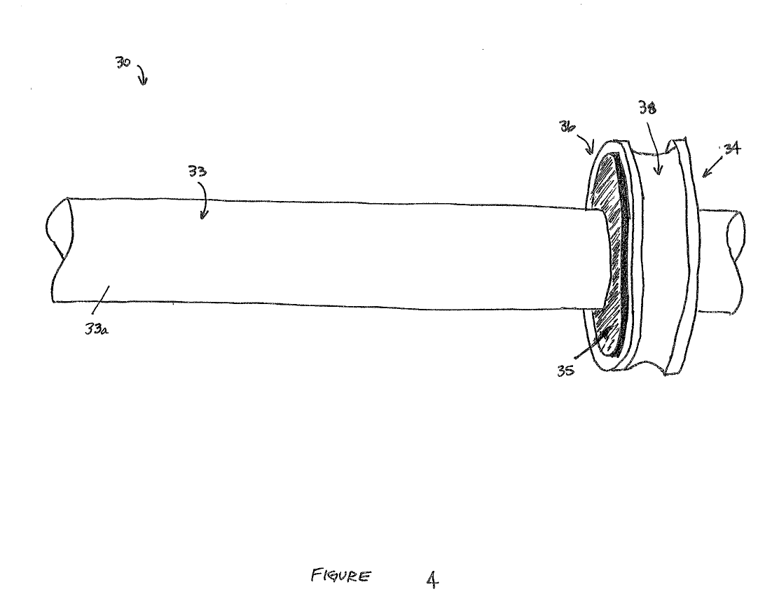

Referring to FIG. 3, a 3-dimensional depiction of the blade shaft 30 is shown separated from the mower 5. At each of the first and second ends of the blade shaft 30, are shown bearing journals 32 for use in mounting to bearings, not shown, in which the bearings are fixedly mounted to the mower deck housing 10. A splined region is shown depicted at 31 and is used for operatively connecting with a rotating driving means 34 (shown in FIG. 4). In the preferred embodiment shown further in FIG. 4, the rotating driving means is a pulley 34 having a splined bore contained therein for mating with the splined region 31 of the blade shaft 30. In an alternate embodiment, a keyway and key could be used to operably connect the rotating driving means 34 to the blade shaft 30. Any such means for operatively connecting said rotating driving means 34 to said blade shaft 30 may be chosen with sound engineering judgment as is appropriate for vegetation cutting devices. A blade region 33 is depicted between the bearing journals 32 and the splined region 31 on which cutting blades 50 are operatively attached.

Referring to FIG. 4, a 3-dimensional depiction of a cutaway view of a blade shaft 30 and pulley 34 are depicted as assembled together. The pulley 34 is shown disposed at an end of the blade shaft 30. The splined hole, not shown, contained therein engages the splined region 31 of the blade shaft 30. A belt groove 38 is shown fashioned in the pulley 34 for use in receiving a tension belt, not shown. As such, belts and pulleys are well known in the art; no further explanation of the use thereof will be offered. In an alternate embodiment, the pulley 34 can be replaced with a sprocket, not shown, and a chain for use in transferring power to the blade shaft 30. A clutch plate 36 is shown juxtaposed and fixedly attached to said pulley 34 for use in transferring power from said pulley 34 and said blade shaft 30 to the cutting blade 50, shown in FIG. 2.

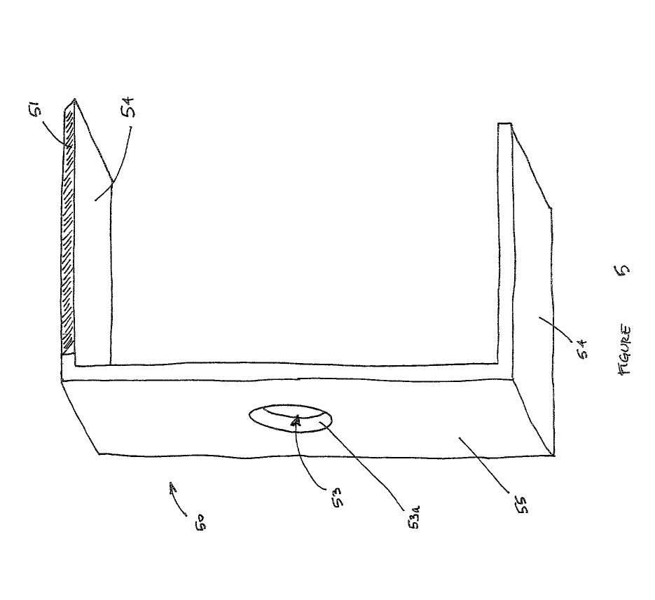

With reference to FIG. 5, a 3-dimensional representation of the cutting blade 50 is shown. In the preferred embodiment, the cutting blade 50 has a ‘U-shaped’ cross-section as shown. The cutting blade 50 has a support member 55, which in the preferred embodiment is generally planar. The support member 55 is shown having first and second ends. Extending, at substantially right angles, from the support member 55 are cutting members 54. The cutting member 54 may extend from the first and second ends of the support member 55. A cutting surface 51 is shown fashioned along a first edge of the cutting members 54, at an angle such that rotating the cutting blade 50 and contacting the cutting blade 50 with the associated vegetation results in the vegetation being cut or severed. Each of the cutting surfaces 51 mounted on each respective cutting member 54 is fashioned on opposing end of the cutting members 54. In this way, rotation of the cutting blade 50 results in a single cutting blade 50 having two cutting surfaces 51 for use in cutting the associated vegetation. The dual cutting surfaces also serve to reduce the rotational rate at which the cutting blades 50 must be rotated to severe the associated vegetation, further resulting in a lower power rating required by the driving means or mower engine 7. Fashioned within the support member 55 is a mounting hole 53 for use in receiving the blade shaft 30. The cutting blades 50 are mounted onto the blade shaft 30, via the mounting hole 53, with a slip fit such that in the event that the cutting blades 50 contact a rock or other obstruction the cutting blades 50 will rotate with respect to the blade shaft 30 reducing damage thereto. Slip fit refers to the clearance between inner diameter 53a of the mounting hole 53 and the outer diameter 33a of the blade shaft 30, as shown in FIG. 4, and more specifically to the friction related between the two adjacent surfaces 53a and 33a. In other words, during rotation of the blade shaft 30 and cutting blades 50, an amount of friction exists between the surfaces 53a and 33a such that, in the event of an obstruction impacting the cutting blades 50 during normal operation of the mower 5, the cutting blades 50 will slip or rotate at a different angular velocity than the blade shaft 30 or possibly even stop with respect to the blade shaft 30. Therefore, the cutting blade 50 is able to rotate independent of the blade shaft 30 under sufficient force as imposed by an obstruction during normal operation of the mower 5. This is especially advantageous for limiting the damage caused to the mower 5 components in the event of an impact upon the cutting blades 50 by an associated obstruction.

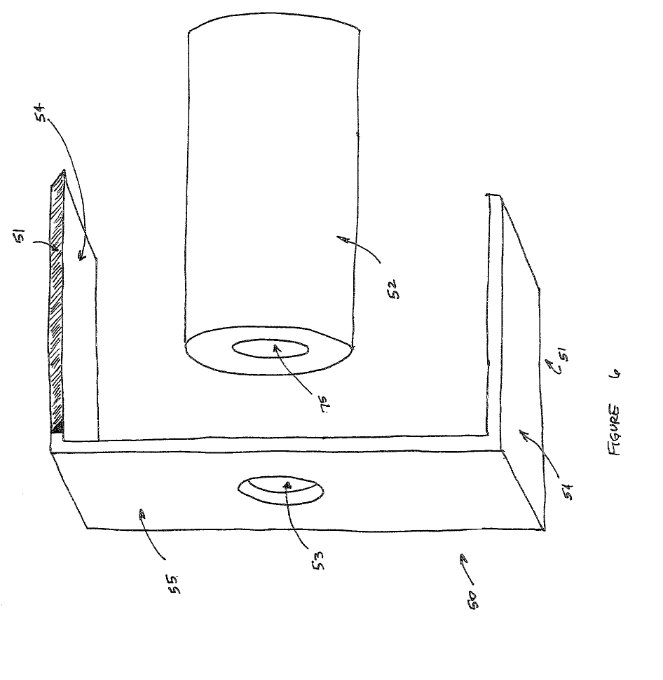

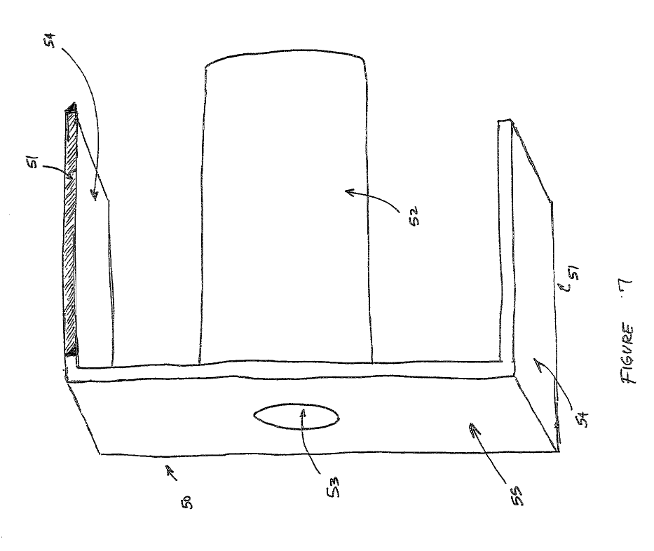

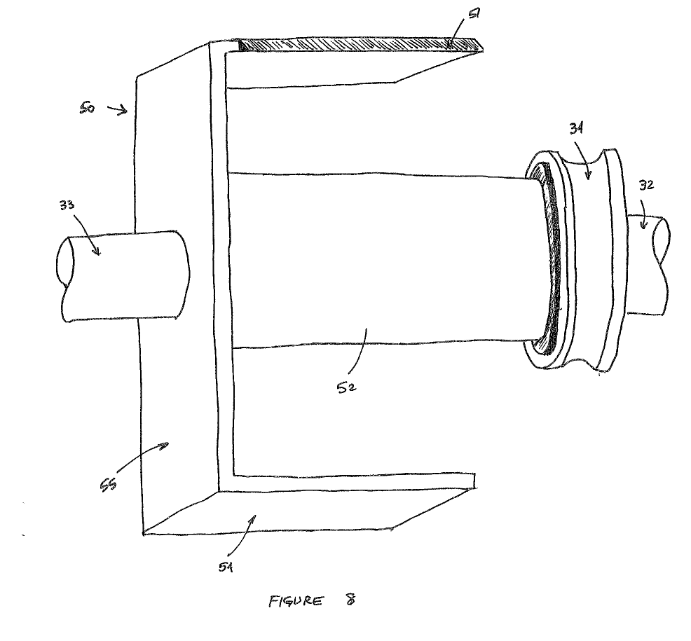

With reference again to FIG. 4, and to FIGS. 6-8, a spacer 52 is shown as being generally tubular in shape. The inner surface 75 of the tubular spacer 52 is for use in receiving the blade shaft 30 and for selectively positioning the cutting blade 50 laterally along the blade shaft 30. FIG. 8 depicts the spacer 52 disposed between the cutting blade 50 and the pulley 34 and the clutch plate 36 respectively. Orientation of the spacer 52 in this way facilitates frictional contact of one end of the spacer 52 against a surface of the clutch plate 36 and, at the other end, frictional contact with a surface of the support member 55 of the cutting blade 50. As described in further detail in a subsequent paragraph, applying a force against the cutting blade 50 such that frictional contact is made between the clutch plate 36, the spacer 52, and the cutting blade 50 facilitates in transferring rotational power from the pulley means 34 to the cutting blade 50. In this way, the cutting blade 50 is rotated with the blade shaft 30 for use in cutting the associated vegetation. Inasmuch as frictional contact exists between the cutting blade 50 and the blade shaft 30, rotation of the blade shaft 30 further assists in transferring rotational power to the cutting blade 50. In an alternate embodiment, the spacer 52 is fixedly attached to the support member 55 of the cutting blade 50 at a first side. The spacer 52 may be integrally fashioned as an extension of the cutting blade 30 or affixed thereto by any such means as chosen with sound engineering judgment, as is appropriate. In this way, the cutting blade 50 has a ‘W-shaped’ cross section. In this embodiment, contact of the spacer extension is still made between the clutch plate 36, resulting in the rotation of the cutting blade 52 and affixed spacer 52.

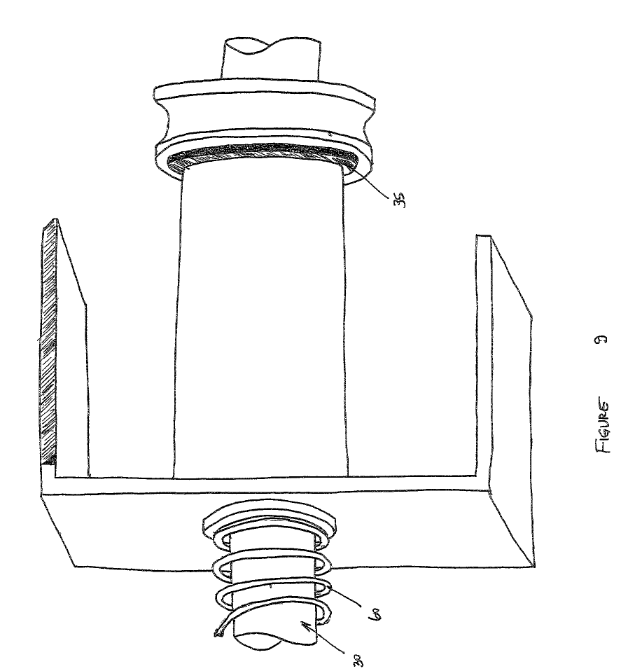

Referring now to FIG. 9, brasing means such as a spring 60 is shown applying a force ‘F’ to a side of the support means 55 of the cutting blade 50. In the preferred embodiment, the spring 60 is a coil spring 60. FIG. 9 shows a partial perspective view of the blade shaft 30 and spring 60. The spring 60 is operatively connected to an inner side of the housing 10, such that the force ‘F’ is applied to the cutting blade 50, causing frictional engagement with the spacer 52 and the clutch plate surface 35 resulting in the aforementioned transfer of rotational power from the pulley means 34 to the cutting blade 50. It should be realized by one skilled in the art that the spring supplying a force F could be provided by a leaf spring or any other means chosen with sound engineering judgment, as is appropriate for applying force to frictionally engage a clutch surface, inasmuch the scope of supplying a force F in this manner should not be limited only to springs.

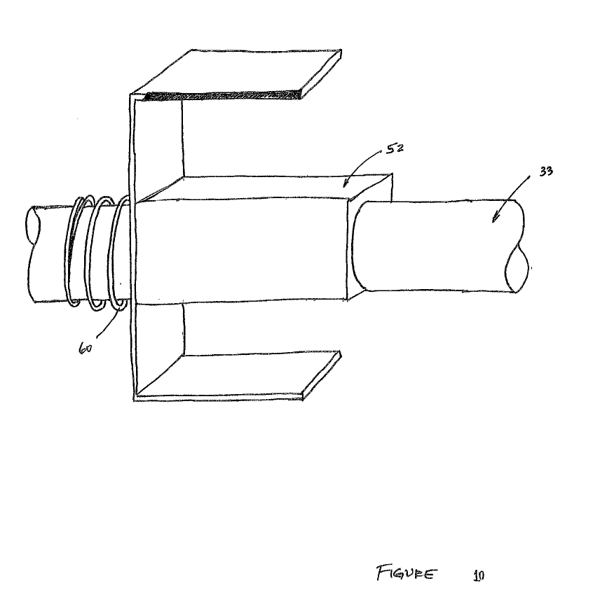

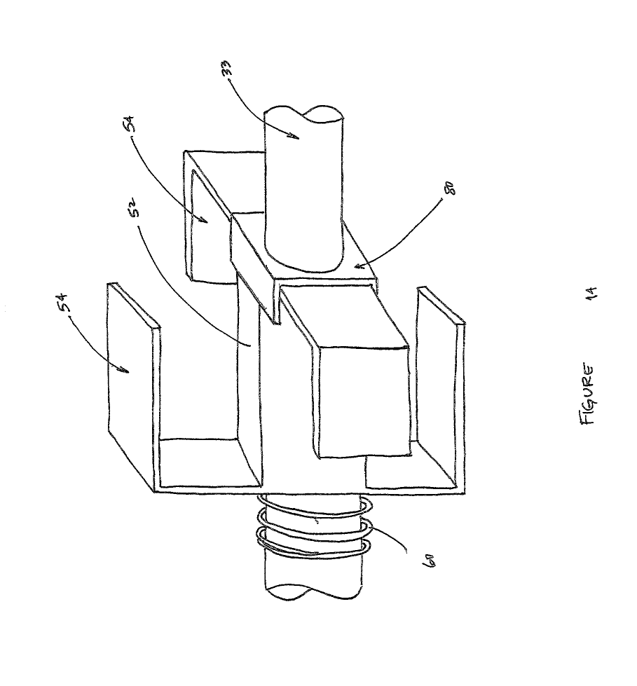

FIG. 10 shows an alternate embodiment of spacer 52, shown depicted therein as having a rectangular exterior surface for use in operatively connecting to an index member 80 (as shown in FIG. 14) discussed in greater detail in a subsequent paragraph. Any such configuration of spacer 52 may be chose with sound engineering judgment for positioning the cutting blade 50 along said blade shaft 30 and for transferring friction force from the pulley means 34 to the cutting blade 50.

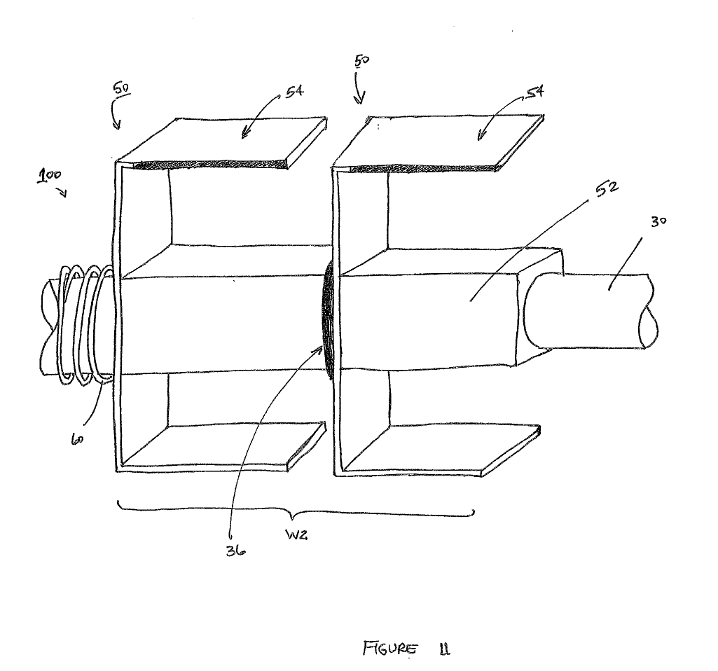

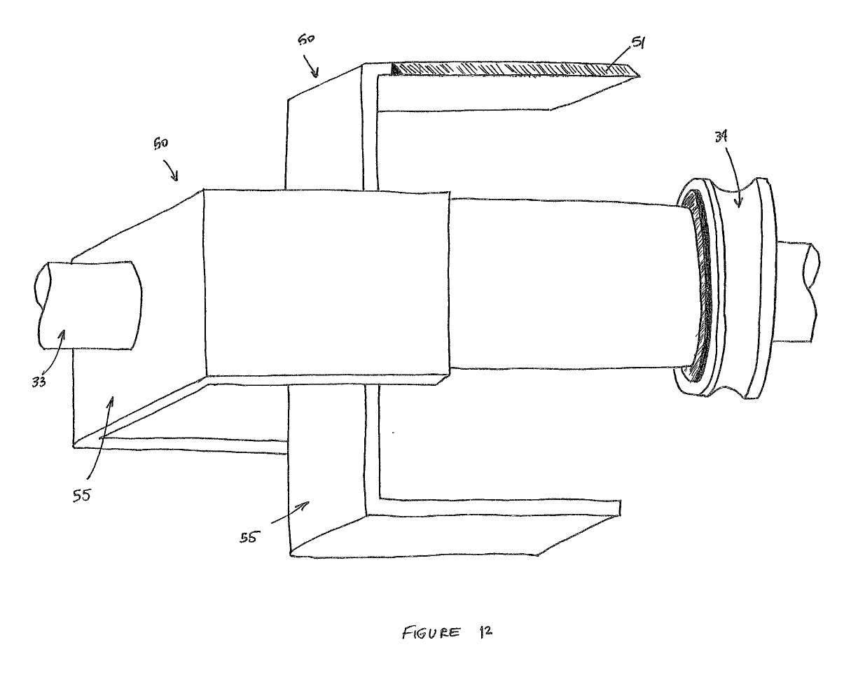

Referring now to FIGS. 11-12, each of the previous figures showed a single cutting blade 50 for the purpose of ease of explanation only. In the preferred embodiment, one or more cutting blades 50 is selectively disposed along the blade shaft 30 for use in altering the cutting width, W2, of the mower 5. Two cutting blades 50 are shown mounted on the blade shaft 30, separated by spacers 52, along with a clutch plate 36 mounted between the cutting blades 50 for use in transferring rotational power to the subsequent cutting blade 50. In this manner, a slip clutch 100 is defined as having a spring 60 and at least one clutch plate 36 for use in transferring power from the pulley 34 to the cutting blades 50. The clutch plates 36 may be disposed between each of the cutting blades 50 and the pulley means 34. The cutting blades 50 are slipingly mounted with respect to each other and the blade shaft 30. Thus, the friction force F applied by the spring force 60 maintains lateral alignment of the cutting blades 50 along the blade shaft 30 and engages the blades 50 in rotational motion with the pulley 34 and blade shaft 30. Obstructions, such as rocks, are commonly found within the terrain in which a mower operates. Contact with the obstruction by one or more of the cutting blades 50 results in a slipping or slow down of rotation of that particular cutting blade 50, as discussed previously. As a result of the slipping, damage to the mower components from contact with an obstructions is minimized. It should noted that after contact with the obstruction the cutting blades 50 may return to rotating substantially synchronously with the blade shaft 30 inasmuch as the slip clutch 100 transfers rotational power to the cutting blades 50.

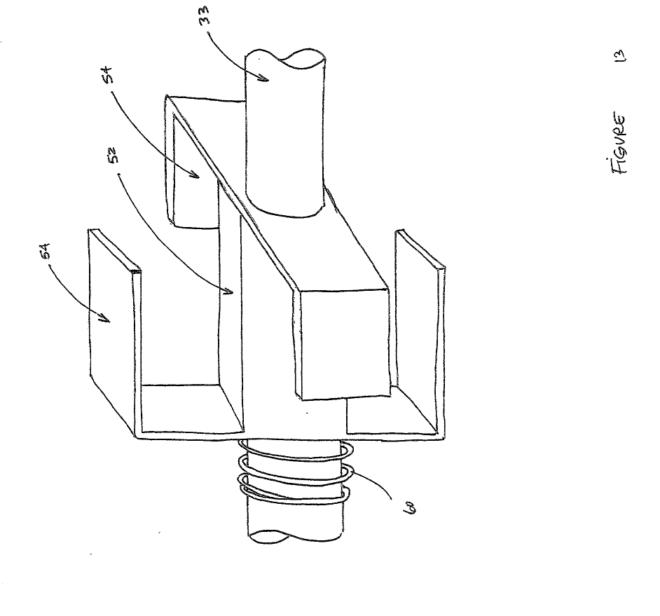

FIGS. 12 and 13 depict an overlapping configuration of blades 50. FIG. 12 depicts a partial view of the blade shaft 30 and two cutting blades 50, wherein each of the cutting blades 50 is facing the same direction. In the preferred embodiment, the cutting blades 50 are ‘U-shaped’ having an open end at the top of the ‘U’ and a closed end at the bottom of the ‘U’. The support member 55 of a first cutting blade 50 is received within the open end of the second cutting blade 50. In this way, the cutting surfaces 51 of each of the cutting blades 50 overlap to enhance the mulching feature of the mower and to increase the quality of cut of the associated vegetation. In that there are additional cutting surfaces, provided by the overlapping blades 50, within the same region of the cutting path, the rotational speed of the blades 50 can be decreased resulting in a reduction in noise output from the mower deck. Additionally, in that the blades 50 contact the grass only during the cutting process, there is reduced drag on the blades 50 by the vegetation. This results in the reduction of the horsepower requirement of the engine 7 further reducing noise and reducing costs to manufacture the mower 5. FIG. 13 shows an alternate configuration of the overlapping cutting blades 50. In this embodiment, the open ends of each of the cutting blades 50 are mutually received within the other.

Referring now to FIG. 14, an index member 80 is shown fixedly attached to one of the cutting blades 50. In the embodiment of FIG. 13 wherein the cutting blades 50 overlap, frictional force tends to maintain the cutting blades 50 in their angular spatial orientation with respect to each other. However, contact with an obstruction can result in an angular displacement of one of the cutting blades 50, further causing contact and damage to the adjacent cutting blade 50. The index member 80, as shown in FIG. 14, maintains constant offset angular positioning of the overlapping cutting blades 50 in the event of contact with an obstruction. In the preferred embodiment, the index member 80 has a ‘U-Shaped’ cross-section and has fashioned therein a mounting hole for receiving the blade shaft 30. FIG. 14 shows the index member 80 fixedly connected to each of the overlapping cutting blades 50, causing an angular offset of 90°, although any degree of angular offset may be chosen with sound engineering judgment. In this embodiment, the rectangular shape of the exterior surface of the spacer 52 matches the configuration of the inner surface, not shown, of the index member 80 for use in maintaining the angular orientation of the cutting blades 50. However, it should be noted that any shape or configuration of the exterior surface of the spacer 52 and matching inner configuration of the index member 80 may be chosen with sound engineering judgment.

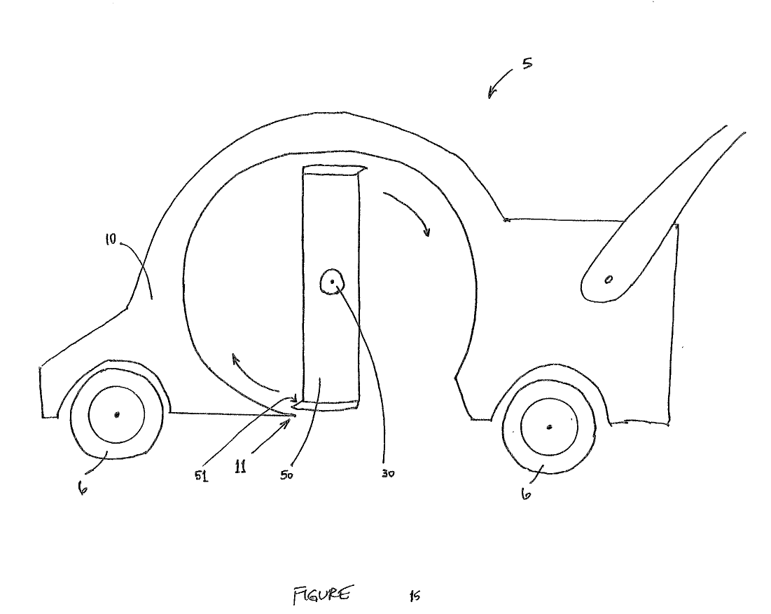

Referring now to FIG. 15, a two-dimensional cutaway view of the mower 5 is shown depicting the cutting blade 50 rotating within the housing 10. A first edge is formed by the interior surface of the mower deck housing shown at 11. The first edge forms a first scissor member 11. The scissor edge 11 extends along the width of the mower 5. Each cutting surface 51 of the cutting blade 50, as it is rotated within the housing 10, passes in close proximity to the scissor member 11 of the housing 10. In this way, each respective cutting surface 51 forms a second scissor member for use in cutting the associated vegetation with scissor like action. Such cutting action increases the quality of the cut and reduces the rotational speed and power requirements of the mower. In the embodiment, as depicted in FIG. 15, the cutting blade 50 is shown rotating clockwise within the housing 10. With an enclosed housing, the configuration of the cutting blades 50 and the configuration of the housing 10 and scissor edge 11 are combined to provide a mulching action of the mower 5. In an alternate embodiment, not shown, a front opening is fashioned within the housing 10 for use in providing a front discharge chute. In another alternate embodiment, the cutting blades 50 can be reversed in and rotated counter-clockwise to facilitate discharging the severed vegetation through a rear discharge chute fashioned in the rear of the mower 5.

Thus, operation of the mower is described in the following manner. An operator attaches one or more cutting blades 50 onto blade shaft 30 according to the desired cut-width and overlapping configuration. Normal operation of the mower 5 transfers power from the engine 7 to the pulley 34. Spring 60 applies a constant force to the cutting blades 50 such that rotational power is transferred from the pulley through the clutch plate 36 to the cutting blades 50. The operator maneuvers the mower 5 along the associated vegetation-cutting surface. In the event that the mower cutting blades 50 encounter an obstruction, the impacted cutting blade 50 will slip about the blade shaft 30 to reduce damage thereto.

While specific embodiments of the invention have been described and illustrated, it is to be understood that these embodiments are provided by way of example only and that the invention is not to be construed as being limited thereto but only by proper scope of the following claims.

It is now claimed:

1. A vegetation mower, comprising:
a mower deck, including,
A. a blade shaft rotatably mounted with respect to said mower deck, said blade shaft disposed substantially horizontally with respect to an associated ground surface; and,
B. at least a first cutting blade adapted to cut associated vegetation, said at least a first cutting blade being slipingly mounted to said blade shaft;
an engine operatively attached to said mower deck for use in providing rotational power to said blade shaft; and,
at least a pair of ground engaging wheels operatively attached to said mower deck; and,
a handle for use in guiding said vegetation mower, said handle extending from said mower deck.

2. The vegetation mower of claim 1, further comprising:
power transferring means operatively attached to said blade shaft for use in transferring rotational power from said engine; and,
a slip clutch disposed on said blade shaft for use in operatively engaging said at least a first cutting blade with said power transferring means.

3. The mower of claim 2, wherein said slip clutch comprises:
a clutch plate disposed between said power transferring means and said at least a first cutting blade for use in frictionally communicating said power transferring means with said at least a first cutting blade; and,
a spring disposed at a second end of said blade shaft providing a force F for use in engaging said at least a first cutting blade with said clutch plate.

4. The mower of claim 1, wherein:
said at least a first cutting blade has a first support portion with a hole fashioned therein for use in slipingly receiving said blade shaft and a first end; and,
at least one cutting member portion extends substantially perpendicular from said first end of said support portion for use in cutting said associated vegetation.

5. The mower of claim 1, wherein said at least a first cutting blade has a first cross section that is U-shaped.

6. The mower of claim 5, further comprising:
at least a second U-shaped cutting blade; and,
wherein an open end of said first cutting blade is juxtaposed to a closed end of said second U-shaped cutting blade for use in adjusting the cutting width of said mower deck.

7. The mower of claim 5, further comprising:
at least a second U-shaped cutting blade; and,
wherein an open end of said first cutting blade is received within an open end of said second cutting for use in overlapping said cutting blades.

8. The mower of claim 7, further comprising:
an index member disposed between said at least first and second cutting blades for use in fixedly positioning said at least a first cutting blade at an angle A with respect to said at least a second cutting blade.

9. The mower of claim 2, wherein said power transferring means comprises:
a pulley fixedly attached at a first end of said blade shaft; and,
a belt communicating power from said engine and to said pulley.

10. The mower of claim 1, wherein said at least a first cutting blade has a first cutting surface that is substantially parallel to a longitudinal axis of said blade shaft.

11. A mower deck, comprising:
a mower deck housing;
a first cutting blade rotatably attached to said mower deck and adapted to cut associated vegetation, said first cutting blade defining a first scissor member;
a second scissor member formed at a first edge of said mower deck housing; and,
wherein said first and second scissor members selectively combine to sever associated vegetation with a scissor cutting action.

12. The mower deck of claim 11 further comprising:
a blade shaft rotatably mounted with respect to said mower deck housing, said blade shaft disposed substantially horizontally with respect to an associated ground surface; and,
said first cutting blade being slipingly mounted to said blade shaft,

13. A mower deck, comprising:
a blade shaft rotatably mounted with respect to said mower deck, said blade shaft disposed substantially horizontally with respect to an associated ground surface; and,
a first cutting blade adapted to cut associated vegetation, said first cutting blade being slipingly mounted to said blade shaft.

14. The mower deck of claim 13 further comprising:
power transferring means operatively attached to said blade shaft for use in transferring rotational power from an associated engine; and,
a slip clutch disposed on said blade shaft for use in operatively engaging said first cutting blade with said power transferring means.

15. The mower deck of claim 14 wherein said slip clutch comprises:
a clutch plate disposed between said power transferring means and said first cutting blade for use in frictionally communicating said power transferring means with said first cutting blade; and,
biasing means for biasing said first cutting blade into operative engagement with said clutch plate.

16. The mower deck of claim 15, further comprising:
a second cutting blade slipingly mounted to said blade shaft for use in selectively adjusting the cutting width of said mower deck; and,
wherein said slip clutch is also for use in operatively engaging said second cutting blade with said power transferring means.

17. A method of changing the cutting width of a mower deck, the steps comprising:
providing a mower deck with a blade shaft rotatably mounted with respect to the mower deck, the blade shaft being disposed substantially horizontal with respect to an associated ground surface;
providing a first cutting blade operatively attached to the blade shaft; and,
attaching a second cutting blade to said blade shaft thereby increasing the cutting width of the mower deck.

18. The method of claim 17, wherein before the step of attaching a second cutting blade to said blade shaft thereby increasing the cutting width of the mower deck, the method comprises the step of:
positioning a first spacer on said blade shaft juxtaposed to the first cutting blade.
